(19) United States
(12) Patent Application Publication
(10) Pub. No.: US 2022/0179838 A1
(43) Pub. Date: Jun. 9, 2022

(54) System and Method for Modification of Storage Engine of Database Table

(71) Applicant: ServiceNow, Inc., Santa Clara, CA (US)

(72) Inventor: Ashwin Kayyoor, Santa Clara, CA (US)

(21) Appl. No.: 17/110,742

(22) Filed: Dec. 3, 2020

(51) Int. Cl. G06F 16/22; G06F 16/21; G06F 11/34; G06F 16/242

(52) U.S. Cl. CPC G06F 16/2282; G06F 16/2423; G06F 11/3409; G06F 16/213

(57) ABSTRACT

A computing system for modification of storage engines of database table is provided. The computing system receives a first user input which includes first information about a first storage engine associated with a database server. The computing system further receives a second user input which includes second information about a second storage engine and a third user input which includes third information about a set of database tables associated with the first storage engine. The computing system further determines a compatibility score which indicates a compatibility between the first storage engine and the second storage engine and further modifies first metadata information, associated with a first database table of the set of database tables, based on the determined compatibility score to modify the storage engine of the first database table from the first storage engine to the second storage engine.

### FIELD

Various embodiments of the disclosure relate to modification of storage engine of database table. More specifically, various embodiments of the disclosure relate to a system and method for modification of storage engine of a database table.

### BACKGROUND

Advancement in database management systems has led to development of various database storage engines each having a different set of properties as well as advantages over other database storage engines. A database storage engine is an internal software component that a database server uses to store, read, update, and delete data in underlying memory and storage systems. The database storage engines also handle the SQL operations for different table types. Therefore, the performance of the database management system to perform certain important operations is purely dependent on the underlying database storage engine used by the database management system.

With the advancement in such database storage engines, many organizations, and individuals may wish to alter their current database storage engines to a new database storage engine to increase the performance related to data storage and data retrieval etc. Traditional methods for altering database storage engines are data size dependent and also result in downtime of service(s), as well as data loss/corruption during the alteration. Therefore, there is a need for a system that can instantly alter the database storage engines without data loss/corruption and service downtime.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for modification of storage engine of database table is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary network environment for modification of storage engines of database table, in accordance with an embodiment of the disclosure.

FIG. 2 is a block diagram of a computing system for modification of storage engine of database table, in accordance with an embodiment of the disclosure.

FIG. 3 is a diagram that illustrates an example electronic user interface for providing input(s) for modification of storage engine for database table, in accordance with an embodiment of the disclosure.

FIG. 4A is a block diagram that describes metadata information, in accordance with an embodiment of the disclosure.

FIG. 4B is a diagram of an exemplary metadata information, in accordance with an embodiment of the disclosure.

FIG. 5 is a flowchart that illustrates an exemplary method for modification of storage engine of database table, in accordance with an embodiment of the disclosure.

### DETAILED DESCRIPTION

The following described implementations may be found in a disclosed system and method for modification of a storage engine of a database table. A database is a collection of inter-related data organized in the form of, but is not limited to, database tables, database views, database schemas, and database reports. The database may support electronic storage and manipulation of data. A database table may correspond to a collection of related data that is held in a table format within the database. The data in the database table is modelled in certain numbers of rows and columns. The database is managed by/controlled by a software known as a database management system (DBMS). The management of the database may include a set of tasks that may include, but is not limited to, data storage, data definitions, data updation, data retrieval, and user administration. The data and the DBMS may be collectively referred as a database system (or a database).

The DBMS may further use a plurality of underlying software's to perform a set of operations. One of the plurality of underlying software's is a storage engine (or a database storage engine or a database engine). The storage engine is an underlying software component that the DBMS may use to perform different operations (such as create, read, update, and delete (CRUD)) on the data stored in the database table. The storage engine may be further responsible for managing how data is stored, both in memory and on a disk. Therefore, the storage engine has a major impact on the performance of the CRUD operations of the database.

Due to dynamic nature of an organization, the organization may have huge amount of data that may be stored across multiple database tables managed by the DBMS. The organization may perform various ad-hoc operations on the stored data to extract insights about a problem (or a business problem) or a task. With the increase in the amount of data stored across multiple database tables, the organization may experience performance degradations (such as slowness, lag) while extracting the insights or performing other operations such as data storage operations or update operations on the data. The underlying storage engines of the database operations may be responsible for performance degradations as the underlying storage engine may be responsible for the create, read, update, and delete (CRUD) operations on the data.

With the advancements in the DBMS, new storage engines may be available in market that may overcome the performance degradations faced by the organization. The organization may want to change the underlying storage engine from an old storage engine to a new storage engine for the improvement in the performance degradations caused by the old storage engine. Traditional methods for changing the storage engines of a database table may include executing an alter command on the database system. A name of the new storage engine may also be provided the alter command. The format of the alter command is provided below:

ALTER TABLE table-name ENGINE=new_storage_engine-name

However, the traditional method (i.e. the execution of the alter command) may have various disadvantages. These disadvantages may include data-size dependency, and data-loss problem. The traditional method may be dependent on the size of data in the table. As a result, for a large size of the data, the traditional method may take several hours or even days to change the storage engines. Moreover, due to the time taken to change the storage engines, the data in the tables may be inaccessible, which may further cause downtime of the services provided by the organization to the customers. In some embodiments, the organization may also incur revenue or customer losses due to non-availability of the data stored in the database tables. Further, the traditional methods may further have data-loss problems as the data is copied from the old storage engine to the new_storage_engine and there may be situations, such as server crash and power failure during the data transfer which may be further time consuming.

Therefore, there is required a computing system that can instantly modify the storage engines of the database tables with minimal down-time of the data/service along with no data loss or data corruption problems. The disclosed computing system may be capable to modify the storage engines of the database tables, irrespective of their sizes, and within a short time-frame (say 1 minute) without any problems related to data loss/data corruption.

Exemplary aspects of the disclosure provide a computing system that may include a computing system. The computing system may receive a first user input which may include first information about a first storage engine associated with a database server. The computing system may further receive a second user input which may include second information about a second storage engine associated with the database server. The computing system may further receive a third user input which may include third information about a set of database tables associated with the first storage engine. The first user input, the second user input, and the third user input may be received for a modification of a storage engine of a first database table of the set of database tables from the first storage engine to the second storage engine. The computing system may further determine a compatibility score which indicates a compatibility between the first storage engine and the second storage engine based on the received first user input, the received second user input, and the received third user input. The computing system may further modify first metadata information, associated with the first database table, based on the determined compatibility score to modify the storage engine of the first database table from the first storage engine to the second storage engine.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized, and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways. Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

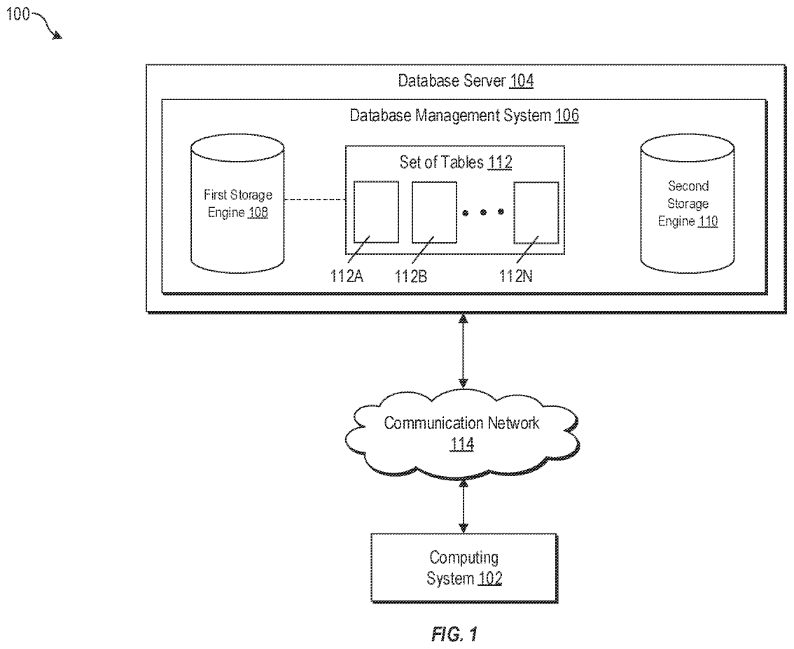

FIG. 1 is a diagram of an exemplary network environment for modification of storage engines of database table, in accordance with an embodiment of the disclosure. With reference to FIG. 1, there is shown a block diagram of a network environment 100. The network environment 100 may include a computing system 102, a database server 104, and a database management system (DBMS) 106. With reference to FIG. 1, there is further shown a first storage engine 108, a second storage engine 110, and a set database tables 112. The set of database tables 112 may include a first database table 112A, a second database table 112B, and an Nth database table 112N. The computing system 102 may be configured to communicate with the database server 104, through a communication network 114.

The computing system 102 may include suitable code, logic, circuitry and/or interfaces that may be configured to modify the storage engine of the first database table 112A from the first storage engine 108 (i.e. source storage engine) to the second storage engine 110 (i.e. destination storage engine). The computing system 102 may receive a first user input and a second user input. The first user input may include or indicate first information about the first storage engine 108 associated with the database server 104, and the second user input may include or indicate second information about the second storage engine 110 associated with the database server 104. The computing system 102 may further receive a third user input. The third input may include or indicate third information about the set of database tables 112. The storage engine of each of the set of database tables 112 may be the first storage engine. Specifically, the third information may include a name of each of the set of database tables 112. The computing system 102 may further determine a compatibility score that may indicate a compatibility between the first storage engine 108 and the second storage engine 110 based on the received first user input, the received second user input, and the received third user input. The computing system 102 may further modify first metadata information associated with a database table (such as the first database table 112A) based on the determined compatibility score to modify the storage engine of the first database table 112A from the first storage engine 108 to the second storage engine 110.

The database server 104 may include suitable logic, circuitry, code and/or interfaces that may be configured to store and manage databases and to provide data access to authorized users. The database server 104 may further performs tasks such as data analysis, storage, data manipulation, archiving, and other non-user specific tasks. The database server 104 may hold the Database Management System (DBMS) 106 that may manage the databases. The database server 104 further may provide database services to the users by executing a database server software. The database server 104 may be typically be seen in a client-server environment and may be responsible to provide information sought by a client system. The database server 104 may control all database functions. The database server 104 may have its own operating system and memory. The database server 104 may be a server that may maintain services related to clients via one or more database applications.

The database management system (DBMS) 106 may include suitable logic, circuitry, code and/or interfaces that may be configured to interact with end users, applications, and the database itself to capture and analyze the data. The DBMS 106 may be a software that may allow creation, definition, and/or manipulation of database; and may further allow the end users to store, process, and analyze data easily. The DBMS 106 may provide an interface or a tool, to perform various operations such as, but is not limited to, creation of database, storage of data, updating data, and creation of tables. The DBMS 106 may be further responsible for the protection and security of the databases and also for data consistency in case of multiple users. The DBMS 106 may be classified based on a database model they support. The database model may be a type of data model that may determine the logical structure of the database and may fundamentally determine a manner in which data may be stored, organized, and manipulated. Examples of the database models may include, but are not limited to, a relational model, a non-relational model, a hierarchical model, a network model, an inverted file model, a graph model, a multi-value model, or an object-oriented database model.

The first storage engine 108 and the second storage engine 110 may include suitable logic, circuitry, code and/or interfaces that may be configured to store and handle data stored in the database. The first storage engine 108 and the second storage engine 110 may be responsible for performing the create, read, update, and delete (CRUD) operations on the data stored in the database. In some embodiments, the first storage engine 108 and the second storage engine 110 may further handle multiple users, transactions, MVCC (Multi-version Concurrency Control), buffers and caches, ACID (atomicity, consistency, isolation, durability), as well as different isolation levels. The DBMS 106 may support a plurality of storage engines including the first storage engine 108 and the second storage engine 110. The first storage engine 108 and the second storage engine 110 may be further responsible for the creation of metadata information after creation of a database table. The metadata information may describe the database table. Each of the plurality of storage engines may be compared with each other based on a plurality of factors that may include, but are not limited to, supported data types, transaction support, database indexing, and locking types. Different types of database engines may include, but are not limited to, a transactional database engine, an embedded database engine, and an in-memory database engine. Examples of the database engines may include, but are not limited to, Aria, Falcon, InnoDB, MyISAM, InfiniDB, TokuDB, WiredTiger, and XtraDB.

The set of database tables 112 may be the most significant component of the database managed by the DBMS 106. The data to be stored in the database is specifically stored in the database tables such as the first database table 112A, the second database table 112B, and the Nth database table 112N. Each database table of the set of database tables 112 may include one or more rows and one or more columns. Each row may be represented horizontally while each of the columns may be represented vertically. Each row is the smallest unit of data that can be inserted into the database and therefore, represent a single record. Each column may contain a definition and/or a value of each field. Each of the set of database tables 112 may be associated with the first storage engine 108. Specifically, the current storage engine of each of the set of database tables 112 may be the first storage engine 108. The user may wish to modify the storage engine of at least one database table of the set of database tables 112 from the first storage engine 108 to the second storage engine 110.

The communication network 114 may represent a portion of the global Internet. However, the communication network 114 may alternatively represent different types of network, such as a private wide-area or local-area packet-switched networks. The communication network 114 may include a communication medium through which the computing system 102, and the database server 104 may communicate with each other. The communication network 114 may be one of a wired connection or a wireless connection Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT)® communication protocols.

In operation, a user of the DBMS 106 may be facing performance degradations while performing the database operations on the data stored in a database table (such as the first database table 112A). The user may therefore wish to change the underlying storage engine of the first database table 112A from the first storage engine 108 to the second storage engine 110. The second storage engine 110 may have better performance in comparison with the first storage engine 108 based on a plurality of factors associated with the second storage engine 110 and/or based on one or more customer reviews about the second storage engine 110. The user may therefore wish to modify the storage engine of the first database table 112A from the first storage engine 108 to the second storage engine 110.

To modify the storage engine of the first database table 112A, the computing system 102 may receive the first user input. The first user input may include the first information about the first storage engine 108 associated with the database server 104. The first information may include or indicate a name of the first storage engine 108. The computing system 102 may further receive the second user input. The second user input may include the second information about the second storage engine 110 associated with the database server 104. The second information may include or indicate a name of the second storage engine 110. The computing system 102 may be further configured to receive a third user input which include third information about the set of database tables 112 associated with the first storage engine 108. The third information may include or indicate a name of each database table of the set of database tables 112. The storage engine of each of the set of database tables 112 may be the first storage engine 108. The first user input, the second user input, and the third user input may be received for a modification of the storage engine of at least one database table (say the first database table 112A) of the set of database tables 112 from the first storage engine 108 to the second storage engine 110.

In some embodiments, the name of the second storage engine in the second information may be mis-spelled or incorrectly provided. In such a scenario, the computing system 102 may be configured to use machine learning algorithms to determine the correct name of the second storage engine 110. In another embodiment, the second information may also include a type-code of the second storage engine 110. The type-code may be a unique identifier of the second storage engine 110.

The computing system 102 may be further configured to create a copy of the first database table 112A of the set of database tables 112 associated with the second storage engine 110. Specifically, the storage engine of the copy of the first database table 112A may be the second storage engine 110. The copy of the first database table 112A may include the data definition parameters and not the actual data. The copy of the first database table 112A may include same number of rows and columns as the first database table 112A but may not contain the data. The copy of the first database table 112A may be sometimes also referred as an empty copy of the first database table 112A. In some embodiments, the computing system 102 may transmit a “create table” command to the database server 104 to create the copy of the first database table. By way of example and not limitation, if the first database table 112A includes 3 columns (such as Name, Age, and Percentage) with datatype for Name being varchar and the datatype for age and percentage being integer, then the transmitted “create table” command be as follows:

CREATE TABLE Copy (
PersonID int,
Name varchar (255),
Age int,
Percentage Int
) ENGINE = name of second storage engine 110;

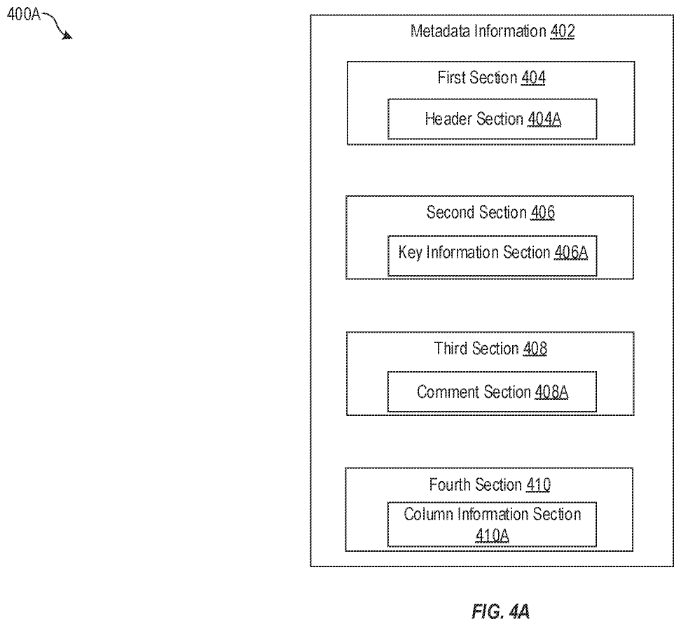

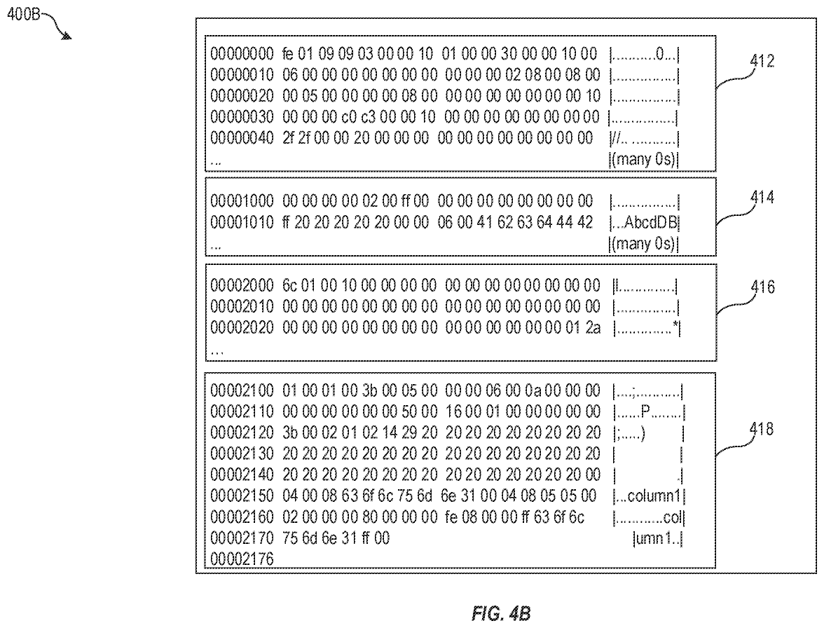

For each created table or a copy of the table, metadata information associated with the corresponding table may be generated by the associated storage engine. For example, first metadata information may be associated with the first database table 112A and second metadata information may be associated with the created copy of the first database table 112A. The metadata information may be bifurcated into a set of sections including first section, a second section, a third section and a fourth section. Each of the set of sections may include a plurality of parameters that may describe the associated table. By way of example and not limitation, the first section may include a first plurality of parameters, the second section may include a second plurality of parameters, the third section may include a third plurality of parameters, and the fourth section may include a fourth plurality of parameters. The generated metadata information may be collaborated in a metadata information file and the metadata information file may be further stored in a memory. In some embodiments, the metadata information file may also be referred as a table format file or a table definition file. The metadata information and the metadata information file are described in detail, for example, in FIGS. 4A and 4B.

Based on the creation of the copy of the first database table 112A, the computing system 102 may be configured to fetch a first metadata information file and a second metadata information file stored in the memory. The computing system 102 may be configured to determine the first metadata information and the second metadata information from the fetched first metadata information file and the second metadata information file, respectively. The computing system 102 may be further configured to determine a first set of parameters from the determined first metadata information and the second metadata information. The first set of parameters may correspond to the first plurality of parameters in the first section of the metadata information. The first set of parameters may include a first parameter associated with a version of the database, a second parameter associated with a minimum number of rows in the associated database table, a third parameter associated with a maximum number of rows in the associated database table, a fourth parameter associated with a key length of a primary key of the associated database table, and a fifth parameter associated with an Input/Output (I/O) size of the associated database table.

The computing system 102 may be further configured to compare the first set of parameters in the first metadata information with the corresponding first set of parameters in the second metadata information. In some embodiments, the computing system 102 may compare the values of all the parameters in the first section of the first metadata information with the values of all the parameters in the first section of the second metadata information. The computing system 102 may further determine a compatibility score that may indicate a compatibility between the first storage engine 108 and the second storage engine 110 based on the comparison.

In an embodiment, the value of each of the first set of pentameters in the first metadata information and in the second metadata information may be same. In such a scenario, first storage engine 108 and the second storage engine 110 may be deemed as compatible and the compatibility score may be set to ‘1’. In another embodiment, the value of at least one of the first set of parameters in the first metadata information and in the second metadata information may be different. In such a scenario, the first storage engine 108 and the second storage engine 110 may be deemed as in-compatible and the compatibility score may be set to ‘0’ by the disclosed computing system 102.

In case the compatibility score is ‘1’, the computing system 102 may be configured to determine a second set of parameters that may be modified to change the storage engine of the first database table 112A from the first storage engine 108 to the second storage engine 110. The second set of parameters may be determined from the second section of the first metadata information. The second set of parameters may include, but is not limited to, a name parameter, and a type-code parameter. The name parameter corresponds to the name of the current storage engine of the first database table 112A (that may be the first storage engine 108). The type-code may correspond to a unique identifier of the current storage engine of the first database table 112A (that may be the first storage engine 108A).

The computing system 102 may further modify the determined second set of parameters (i.e. name, type-code) in the first metadata information to modify the storage engine of the first database table 112A. The modification of the second set of parameters may be based on the received second input. The value of the name parameter in the second set of parameters may be modified from the name of the first storage engine 108 to the name of the second storage engine 110 as received in the second input. Similarly, the computing system 102 may modify the type-code parameter to reflect the type-code of the second storage engine 110. In some embodiments, information about the type-code may also be received in the second input. In some other embodiments, the type-code of various storage engines may be prestored in the memory. The computing system 102 may be configured to retrieve and change the type-code of the second storage engine 110 based on the name of the second storage engine received in the second input. In some embodiments, the computing system 102 may be configured to transmit a modify parameter command to the database server 104. The database server 104 may execute the received modify parameter command to modify the determined second set of parameters in the first metadata information.

After the modification of the second set of parameters, the computing system 102 may be configured to transmit a command to the database server to further re-start the database server 104. The database server 104 may be re-started to reflect the modification of the first metadata information. After the restart, the storage engine of the first database table 112A may be modified from the first storage engine 108 to the second storage engine 110. Hence based on the modification of the second set of parameters (i.e. name, type-code), the disclosed computing system 102 may instantly modify the storage engine of a database by modifying the metadata information of the database table only. The disclosed computing system 102 may only modify the metadata of the database table without any operation with the data stored in the database table. This reduces the risk of data loss or data corruption during the process of modification of the storage engines. Since the time taken to modify the second set of parameters is significant less (may be in few seconds), therefore the disclosed computing system 102 may be capable to instantly alter the storage engine of a database table, such that the customers or the users of the corresponding database may not feel that the storage engine has been altered.

In case the compatibility score is ‘0’, the computing system 102 may be configured to use the traditional method, as described above, to alter the storage engine of the first database table 112A. The computing system 102 may transmit an alter command to the database server 104 to modify the storage engine of the first database table 112A based on the determination that the compatibility score is 0. After the execution of the alter command, the storage engine of the first database table 112A of the set of database tables 112 may be modified from the first storage engine 108 to the second storage engine 110. However, the traditional method may be data dependent and may incur a risk of data loss/data corruption as descried above.

It may be noted that although the computing system 102 and the database server 104 are shown as two components. A person with ordinary skill in the art will understand that the scope of the disclosure is not limited to an implementation of the computing system 102 and the database server 104 as separate entities. In accordance with an embodiment, the functionalities of the database server 104 may be implemented by the computing system 102, without departure from the scope of the disclosure.

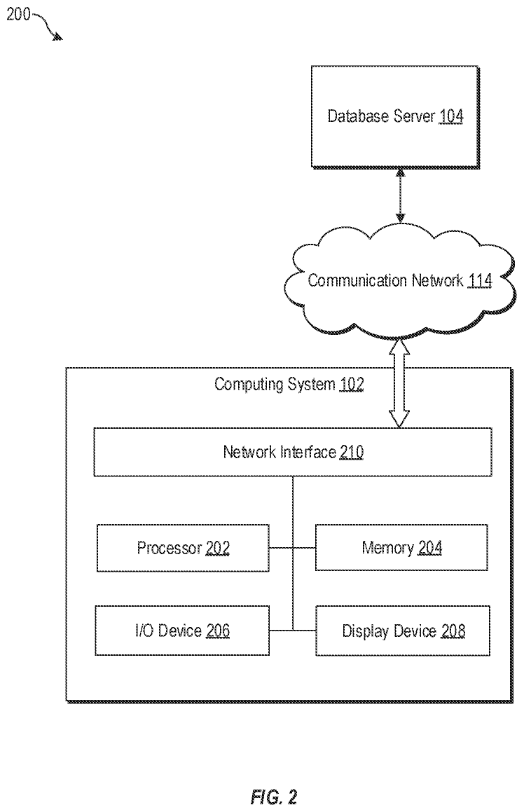

FIG. 2 is a block diagram of a computing system for modification of storage engine of database table, in accordance with an embodiment of the disclosure. FIG. 2 is explained in conjunction with elements from FIG. 1. With reference to FIG. 2, there is shown a block diagram 200 of the computing system 102. The computing system 102 may processor 202, a memory 204, an input/output (I/O) device 206, a display device 208, and a network interface 210.

The processor 202 may include suitable logic, circuitry, interfaces, and/or code that may be configured to execute instructions for operations to be executed by the computing system 102 to modify the storage engine of a database table. For example, the operations may include, but is not limited to, receipt of the first input, second input and third input, determination of the compatibility score, and the modification of the first metadata information to modify the storage engine. Examples of implementation of the processor 202 may include a Central Processing Unit (CPU), x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), co-processors, other processors, and/or a combination thereof.

The memory 204 may include suitable logic, circuitry, code, and/or interfaces that may be configured to store the instructions executable by the processor 202. The memory 204 may store the received first information, the second information, and the third information. The memory may be further configured to store information about a plurality of storage engines. The stored information may include, but is not limited to, the name and the type-code of each of the plurality of storage engines supported by the DBMS 106. Examples of implementation of the memory 204 may include, but are not limited to, Random Access Memory (RAM), Read Only Memory (ROM), Hard Disk Drive (HDD), and/or a Secure Digital (SD) card.

The I/O device 206 may include suitable logic, circuitry, and/or interfaces that may be configured to receive one or more inputs and provide an output based on the received one or more inputs. The first input, the second input, and the third input may be received via the I/O device 206. The I/O device 206 may include various input and output devices, which may be configured to communicate with the processor 202. Examples of the I/O device 206 may include, but are not limited to, a touch screen, a keyboard, a mouse, a joystick, a display device (e.g., the display device 208), a microphone, or a speaker.

The display device 208 may include suitable logic, circuitry, interfaces, and/or code that may be configured to render an electronic UI onto a display screen of the display device 208. In one or more embodiments, multiple user inputs may be received directly, via the display device 208. In such cases, the display screen of the display device 208 may be a touch screen to receive the multiple user inputs. The display device 208 may be realized through several known technologies such as, but not limited to, a Liquid Crystal Display (LCD) display, a Light Emitting Diode (LED) display, a plasma display, and/or an Organic LED (OLED) display technology, and/or other display technologies. Additionally, in some embodiments, the display device 208 may refer to a display screen of smart-glass device, a 3D display, a see-through display, a projection-based display, an electro-chromic display, and/or a transparent display.

The network interface 210 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 210 may communicate via wireless communication with networks, such as the Internet, an Intranet, and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120 g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The functions or operations executed by the computing system 102, as described in FIGS. 1, 3, 4A, 4B, and 5 may be performed by the processor 202. Operations executed by the processor 202 are described in detail, for example, in FIGS. 1, 3, 4A, 4B, and 5. Modifications, additions, or omissions may be made to the computing system 102 without departing from the scope of the present disclosure. For example, in some embodiments, the computing system 102 may include any number of other components that may not be explicitly illustrated or described.

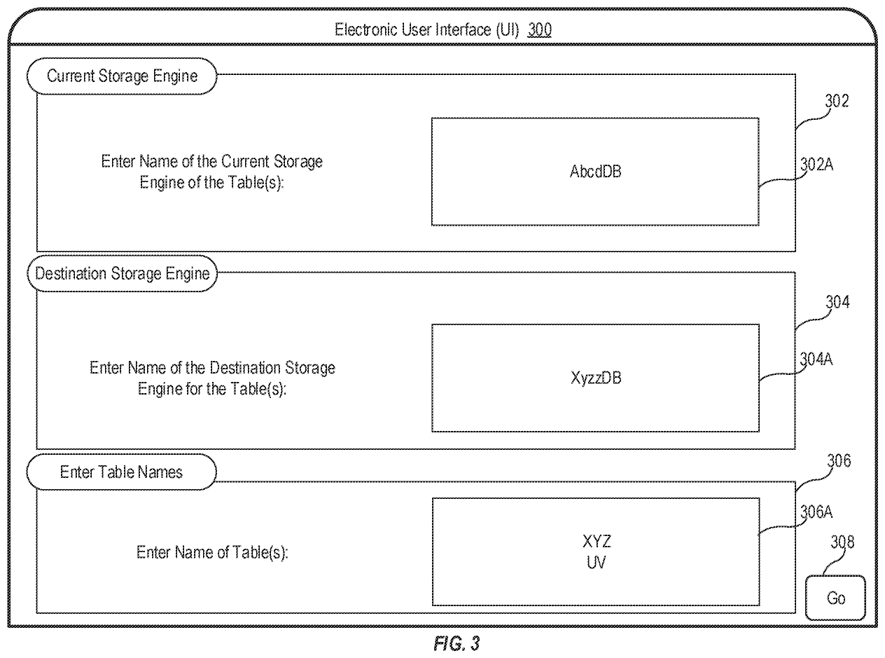

FIG. 3 is a diagram that illustrates an example electronic user interface for providing input(s) for modification of storage engine for database table, according to an embodiment described in the present disclosure. FIG. 3 is explained in conjunction with elements from FIG. 1 and FIG. 2. With reference to FIG. 3, there is shown an electronic user interface (UI) 300. The electronic UI 300 may be displayed on the display screen of the display device 208 based on a user request, which may be received via an application interface (such as I/O device 206). The application interface may be part of an application software, for example, a software development kit (SDK), a cloud server-based application, a web-based application, an OS-based application/application suite, an enterprise application, a mobile application for modification of the storage engines of database tables.

In FIG. 3, on the electronic UI 300, there is shown a set of UI elements, such as a first UI element 302, a second UI element 304, a third UI element 306, and a fourth UI element 308. In FIG. 3, the first UI element 302 is labelled as, for example, “Current Storage Engine”. The first UI element 302 may include a current storage engine name textbox 302A. The computing system 102 may receive, via the current storage engine name textbox 302A, the first user input including the first information about the first storage engine 108 associated with the database server 104.

The current storage engine name textbox 302A may allow the user to provide the first user input as a name of the first storage engine 108 (i.e. Current Storage Engine). The first storage engine 108 may be the storage engine of each database table of the set of database tables 112. In some embodiments, the first storage engine 108 may be a default storage engine for all the database tables in the database. The first user input may be received for the modification of the storage engine of at least the first database table 112A of the set of database tables 112 from the first storage engine 108 to the second storage engine 110.

As shown in FIG. 3, the second UI element 304 is labelled as, for example, “Destination Storage Engine”. The second UI element 304 may include a destination storage engine name textbox 304A. The computing system 102 may receive, via the destination storage engine name textbox 304A, the second user input including the second information about the second storage engine 110 associated with the database server 104. The destination storage engine name textbox 304A may allow the user to provide the second user input as a name of the second storage engine 110. Each of the set of database tables 112 may have to be modified to the second storage engine 110. In some embodiments, at least one of the set of database tables 112 may have to be modified to the second storage engine 110. The second user input may be received for the modification of the storage engine of at least the first database table 112A of the set of database tables 112 (or at least one table) from the first storage engine 108 to the second storage engine 110.

As shown in FIG. 3, the third UI element 306 is labelled as, for example, “Enter Table Names”. The third UI element 306 may include a table name textbox 306A. The computing system 102 may receive, via the table name textbox 306A, the third user input including the third information about the set of database tables 112 whose storage engine has to be modified. The table name textbox 306A may allow the user to provide the third user input as a name of each database table of the set of database tables 112 for the modification of their storage engines. The third user input may be received for a modification of the storage engine of at least the first database table 112A of the set of database tables 112 from the first storage engine 108 to the second storage engine 110.

By way of example, and not limitation, if the user may wish to change the storage engine of the database tables with table-name as ‘XYZ’ and ‘UV’ from ‘AbcdDB’ to ‘XyzzDB’, then the first input received via the current storage engine name textbox 302A may include ‘AbcdDB’ as the first information. The second input received via the destination storage engine name textbox 304A may include ‘XyzzDB’ as the second information. Similarly, the third input, received via the table name textbox 306A, may include ‘XYZ’, and ‘UV’ as the third information. As shown in FIG. 3, the fourth UI element 308 may be labelled as, for example, “Go” and may be button. Upon a selection of the button, the computing system 102 may determine the compatibility score and further modify the storage engine of each (or at least one) of the set of database tables 112 (indicated by the third input), from the first storage engine 108 (i.e. indicated by the first input), to the second storage engine 110 (i.e. indicated by the second input), based on the determined compatibility score, as further described for example, in FIGS. 4A-4B. It should be noted that the electronic UI 300 is merely provided as an exemplary example to illustrate receiving of the first user input, the second user input, and the third user input and should not be construed as limiting for the present disclosure.

FIG. 4A is a block diagram that describes metadata information, in accordance with an embodiment of the disclosure. FIG. 4A is explained in conjunction with elements from FIG. 1, FIG. 2, and FIG. 3. With reference to FIG. 4A, there is shown block diagram 400A of the metadata information that is associated with each database table of the set of database tables 112 in a database managed by the DBMS 106.

Every database table created in the DBMS 106 may have be represented in the memory (or on the disk) as a metadata information file. After the creation of a database table, the associated metadata information file may be automatically created by the storage engine associated with the created database table. The metadata information file may be a binary file and may include metadata information 402 that may describe the associated database table. The metadata information 402 may describe a format (or the table definition) of the associated table and further may include one or more fields of the associated database table along with the structure of the associated database table. In some embodiments, the metadata information file may have the same name as the name of the associated database table but may have a different file extension, such as but not limited to, “.frm” (FoRMat) file extension. By way of example and not limitation, if the name of the database table is “XYZ”, then the associated metadata information file may be saved as a “XYZ.frm” file.

As shown in FIG. 4A, the metadata information 402 stored in the metadata information file may include (for example) four sections i.e. a first section 404, a second section 406, a third section 408, and a fourth section 410. The first section 404 may correspond to a header section (such as header section 404A shown in FIG. 4A). The second section 406 may correspond to a key information section (such as key information section 406A shown in FIG. 4A). Similarly, the third section 408 of the metadata information may correspond to a comment section (such as comment section 408A shown in FIG. 4A), and the fourth section 410 may correspond to a column information section (such as column information section 410A shown in FIG. 4A).

The first section 404 may correspond to the header section and may constitute of 64 bytes that may encode information about the rest of the “.frm” file and various table level options. The first section 404 (i.e. the header section) may include a first plurality of parameters that may be presented in Table 1 as follows:

TABLE 1
First Plurality of Parameters in First Section

| Offset | Length | Explanation |
|---|---|---|
| 0000 | 1 | Always |
| 0001 | 1 | Always |
| 0002 | 1 | FRM_VERSION |
| 0003 | 1 | legacy_db_type |
| 0004 | 1 | names_length |
| 0005 | 1 | Always |
| 0006 | 2 | IO_SIZE |
| 0008 | 2 | number of “forms” in the .frm |
| 000a | 4 | Length, based on key_length + |
| | | rec_length + create_info->extra_size |
| 000e | 2 | ″tmp key length″, |
| 0010 | 2 | rec length |
| 0012 | 4 | create_info->max_rows |
| 0016 | 4 | create_info->min_rows |
| 001b | 1 | Always (means “use long pack-fields”) |
| 001c | 2 | key_info_length |
| 001e | 2 | create_info->table_options |
| 0020 | 1 | Always |
| 0021 | 1 | Always (means “version 5 frm file”) |
| 0022 | 4 | create_info->avg_row_length |
| 0026 | 1 | create_info->default_table_charset |
| 0027 | 1 | Always |
| 0028 | 1 | create_info->row_type |
| 0029 | 6 | Always (formerly used for RAID support) |
| 002f | 4 | key_length |
| 0033 | 4 | MYSQL_VERSION_ID |
| 0037 | 4 | create_info->extra_size |
| 003b | 2 | extra_rec_buf_length |
| 003d | 1 | Storage engine if table is partitioned |
| 003e | 2 | create_info->key_block_size |

With reference to Table 1, the cell values corresponding to the offset column may correspond to the byte position of the corresponding parameter in the metadata information file. The cell values corresponding to the length column may describe a length of the corresponding parameter in bytes. The cell values corresponding to the explanation column may correspond to a brief description of the corresponding parameter in the header section of the metadata information.

The second section 406 may correspond to the key information section and start at offset “1000” (i.e. 4096 in decimal). The second section 406 may include a second plurality of parameters that may be presented in Table 2 as follows:

TABLE 2
Second Plurality of Parameters in the Second Section.

| Offset | Length | Explanation |
|---|---|---|
| 1000 | 1 | Always 00 when there are no keys |
| | | (that is, indexes) |
| 101a | 6 | Name of engine. If partitioning, |
| | | the partition clauses are here |

With reference to Table 2, the cell values corresponding to the offset column may correspond to the byte position of the corresponding parameter in the metadata information file. The cell values corresponding to the length column may describe a length of the corresponding parameter in bytes. The cell values corresponding to the explanation column may correspond to a brief description of the corresponding parameter in the key information section of the metadata information.

The third section 408 may correspond to the comment information section and may start at offset “202e”. The third section 408 may provide information about one or more comments associated with the corresponding database table. The third section 408 may include a third plurality of parameters that may be presented in Table 3 as follows:

TABLE 3
Third Plurality of Parameters in the Third Section

| Offset | Length | Explanation |
|---|---|---|
| 202e | 1 | Length of comment |
| 202f | 40 | The string in the COMMENT table option |

With reference to Table 3, the cell values corresponding to the offset column may correspond to the byte position of the corresponding parameter in the metadata information file. The cell values corresponding to the length column may describe a length of the corresponding parameter in bytes. The cell values corresponding to the explanation column may correspond to a brief description of the corresponding parameter in the comment section of the metadata information.

The fourth section 410 may correspond to the column information section and may start at offset “2100”. The fourth section 410 may provide information about one or more columns present in the corresponding database table. The fourth section 410 may include a fourth plurality of parameters that may be presented in Table 4 as follows:

TABLE 4
Fourth Plurality of Parameters in the Fourth Section.

| Offset | Length | Explanation |
|---|---|---|
| 2100 | 2 | Always |
| 2102 | 2 | share->fields |
| 2104 | 2 | pos (“length of all screens”) |
| 2106 | 2 | Based on number of bytes in row. |
| 210c | 2 | n_length. |
| 210e | 2 | interval count. |
| 2110 | 2 | interval parts. |
| 2112 | 2 | int_length |
| 211a | 2 | share->null fields |
| 211c | 2 | com_length |
| 2152 | 1 | Length of column-name including ′\0′ termination |
| 2153 | 3 | column-name |
| 215b | 1 | ?? |
| 215c | 1 | ?? |
| 215d | 1 | Number of bytes in column |
| 215e | 1 | Number of bytes in column |
| 215f | 4 | |
| 2163 | 1 | Flags for zerofill, unsigned, etc. |
| 2164 | 1 | Additional flags, and scale if decimal/numeric |
| 2168 | 1 | Data type (fe = char, 02 = smallint, 03 = int, etc.) |
| 2169 | 1 | Character set or geometry type |
| (later) | ?? | Column names again |
| 202e | 1 | Length of comment |
| 202f | 40 | The string in the COMMENT table option |

With reference to Table 4, the cell values corresponding to the offset column may correspond to the byte position of the corresponding parameter in the metadata information file. The cell values corresponding to the length column may describe a length of the corresponding parameter in bytes. The cell values corresponding to the explanation column may correspond to a brief description of the corresponding parameter in the column information section of the metadata information.

In accordance with an embodiment, to determine the compatibility score, the computing system 102 may be further configured to determine the first set of parameters from the determined first metadata information associated with the first database table 112A and the second metadata information associated with the first database table 112A. The first set of parameters may correspond to the first plurality of parameters (shown in Table 1) in the first section 404 of the metadata information. In an embodiment, the first set of parameters may include, but is not limited to, a first parameter associated with a version of the database (e.g. at offset 0033), a second parameter associated with a minimum number of rows in the associated database table (e.g. at offset 0016), a third parameter associated with a maximum number of rows in the associated database table (e.g. at offset 0012), a fourth parameter associated with a key length of a primary key of the associated database table (e.g. at offset 0020, and a fifth parameter associated with an Input/Output (I/O) size of the associated database table (e.g. at offset 0006). In another embodiment, the first set of parameters may include all the parameters of Table 1.

Specifically, the computing system 102 may be further configured to compare the first plurality of parameters (as provided in Table 1) of the first section 404 in the first metadata information with the corresponding first plurality of parameters (as provided in Table 1) of a first section (such as first section 404) in the second metadata information. The second metadata information may be associated with the copy of the associated database table that may be associated with the second storage engine 110 as described, for example, in FIG. 1. The computing system 102 may further determine a compatibility score that may indicate a compatibility between the first storage engine 108 and the second storage engine 110 based on the comparison.

In an embodiment, the value of each of the first plurality of parameters (as provided in Table 1) in the first metadata information and in the second metadata information may be same. In such a scenario, the first storage engine 108 and the second storage engine 110 may be deemed as compatible and the compatibility score may be set to ‘1’. In another embodiment, the value of at least one of the first plurality of parameters (as provided in Table 1) in the first metadata information and in the second metadata information may be different. In such a scenario, the first storage engine 108 and the second storage engine 110 may be deemed as in-compatible and the compatibility score may be set to ‘0’.

In case the compatibility score is ‘1’, the computing system 102 may be configured to determine a second set of parameters of the second plurality of petameters (as provided in Table 2) that may be modified to change the storage engine of the first database table 112A from the first storage engine 108 to the second storage engine 110. The second set of parameters may include, but is not limited to, a name parameter (e.g. at offset 101a), and a type-code parameter (for example offset is of four bytes). The details about the modification of the second set of parameters are provided in FIG. 4B.

FIG. 4B is a diagram of an exemplary metadata information, in accordance with an embodiment of the disclosure. FIG. 4B is explained in conjunction with elements from FIG. 1, FIG. 2, FIG. 3, and FIG. 4A. With reference to FIG. 4B, there is shown an exemplary metadata information 400B in a metadata information file associated with a database table.

With reference to FIG. 4B, there is further shown first metadata 412, second metadata 414, third metadata 416, and fourth metadata 418. The first metadata 412 may represent the first section 404 of the metadata information 402 (shown in FIG. 4A). The second metadata 414 may represent the second section 406 of the metadata information 402. The third metadata 416 may represent the third section 408 of the metadata information 402 and the fourth metadata 418 may represent the fourth section 410 of the metadata information 402. The first metadata 412 may start with the offset “0000” and may end with offset “003e”. The second metadata 414 may start with the offset “0100” and may end with offset “101a”. The third metadata 416 may start with the offset “202e” and may end with offset “202f”. Similarly, the fourth metadata 418 may start with the offset 2100 and ends with an end of the metadata information in the metadata information file.

The processor 202 of the computing system 102 may compare the first metadata 412 (i.e. first metadata information) associated with the first database table 112A with first metadata (not shown) associated with the copy of the first database table 112A (i.e. associated with second engine) to determine the compatibility score, as described for example FIG. 1. In some embodiments, the first metadata associated with the copy of the first database table 112A may also be referred as second metadata information. If the compatibility score is “1”, the computing system 102 may further modify one or more of the second plurality of parameters in the second metadata 414 to modify the storage engine of the first database table 112A from the first storage engine 108 to the second storage engine 110. Specifically, the computing system 102 may modify the values corresponding to the offset 101a (in Table 2), as the value corresponding to the offset 101a indicates the name of the storage engine associated with the first database table 112A.

With reference to FIG. 4B and by way of an example, the name of the current storage engine 108A may be “AbcdDB” that may be represented by hexadecimal by “41 62 63 64 44 42”. To change the storage engine of the associated database table from “AbcdDB” to “XyzzDB”, the computing system 102 may be configured to modify the hexadecimal representation of the “AbcdDB” with the hexadecimal representation of the “XyzzDB”. The computing system 102 may replace “41 62 63 64 44 42” with “58 79 7a 7a 44 42” in the metadata information 402 to modify the storage engine.

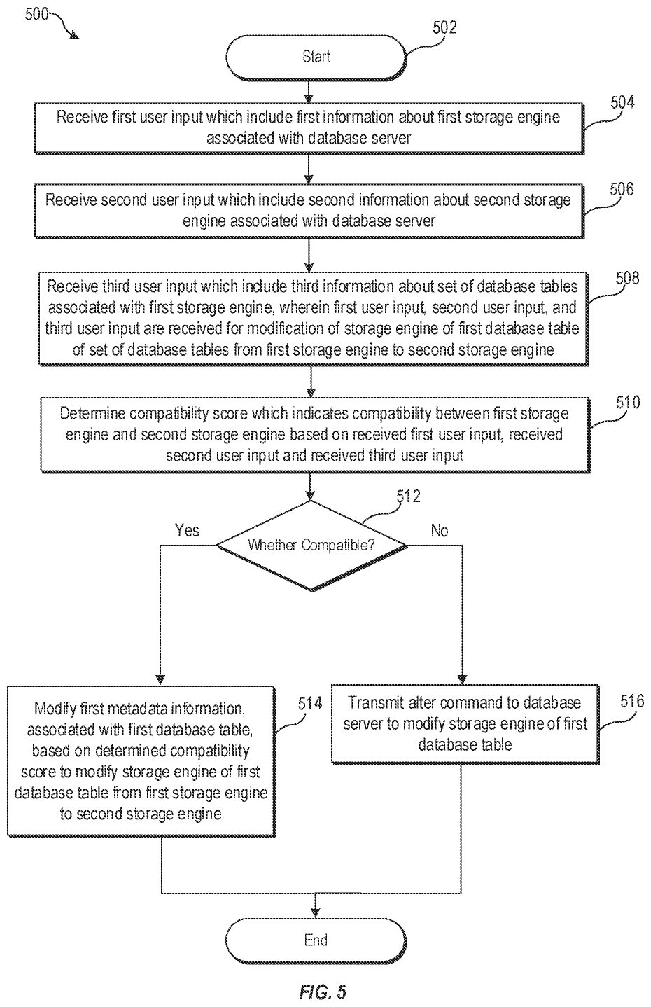

FIG. 5 is a flowchart that illustrates an exemplary method for modification of storage engine of database table, in accordance with an embodiment of the disclosure. FIG. 5 is described in conjunction with elements from FIGS. 1, 2, 3, 4A, and 4B. With reference to FIG. 5, there is shown a flowchart 500. The exemplary method of the flowchart 500 may be executed by any computing system, for example, by the computing system 102 of FIG. 1 or the processor 202 of FIG. 2. The exemplary method of the flowchart 500 may start at 502 and proceed to 504.

At 504, the first user input may be received. The first user input may include the first information about the first storage engine 108 associated with the database server 104. In one or more embodiments, the computing system 102 may be configured to receive the first user input via the electronic UI 300. The details about the reception of the first user input are provided, for example, in FIG. 1 and FIG. 3.

At 506, the second user input may be received. The second user input may include the second information about the second storage engine 110 associated with the database server 104. In one or more embodiments, the computing system 102 may be configured to receive the second user input via the electronic UI 300. The details about the reception of the second user input are provided, for example, in FIG. 1 and FIG. 3.

At 508, third input may be received. The third user input may include the third information about a set of database tables 112. Each of the set of database tables 112 may be associated with the first storage engine 108. In one or more embodiments, the computing system 102 may be configured to receive the third user input via the electronic UI 300. The details about the reception of the third user input are provided, for example, in FIG. 1 and FIG. 3. The first user input, the second user input, and the third user input may be received for a modification of a storage engine of a database table (such as first database table 112A) of the set of database tables 112 from the first storage engine 108 to the second storage engine 110.

At 510, a compatibility score may be determined. The compatibility score may indicate a compatibility between the first storage engine 108 and the second storage engine 110 and may be further determined based on the received first user input, the received second user input, and the received third user input. In one or more embodiments, the computing system 102 may be configured to determine the compatibility score which indicates the compatibility between the second storage engine 110 and the first storage engine 108A based on the received first user input, the received second user input, and the received third user input. The details about determination of the compatibility score are provided, for example, in FIG. 1 and FIG. 4A.

At 512, it may be determined whether the first storage engine 108 and the second storage engine 110 are compatible. The compatibility of the first storage engine 108 and the second storage engine 110 may be based on the determined compatibility score. In case the second storage engine 110 and the first storage engine 108 are compatible, the control may be passed to 514. Otherwise, the control may pass to 516.

At 514, the first metadata information may be modified. The first metadata information associated with the first database table 112A may be modified based on the determined compatibility score. The first metadata information may be modified to modify the storage engine of the first database table 112A from the first storage engine 108 to the second storage engine 110. In one or more embodiments, the computing system 102 may be configured to modify the first metadata information, associated with the first database table 112A, based on the determined compatibility score, from the first storage engine 108 to the second storage engine 110, as described for example in FIG. 1 and FIG. 4A. Control may pass to end.

At 516, an alter command may be transmitted to the database server 104. The alter command may be transmitted based on the determined compatibility score that may indicate the first storage engine 108 and the second storage engine 110 are not compatible to each other. The alter command may be transmitted to modify the storage engine of the first database table 112A from the first storage engine 108 to the second storage engine 110. By way of example and not limitation, if the name of the first database table 112A is abc′ and the name of the second storage engine is ‘XyzzDB’, then the alter command is given as:

ALTER TABLE abc ENGINE=XyzzDB

The database server 104 may receive the alter command and further execute the alter command. After the execution of the alter command, the storage engine of the first database table 112A may be modified from the first storage engine 108 to the second storage engine 110. However, this process may be time-consuming and may also involve a risk of data loss/data corruption, as described for example in FIG. 1. Control may pass to end.

Although the flowchart 500 is illustrated as discrete operations, such as 502, 504, 506, 508, 510, 512, 514, and 516, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions executable by a machine and/or a computer to operate a computing system (e.g., the computing system 102) for modification of storage engine of database table. The computer-executable instructions may cause the machine and/or computer to perform operations that may include reception of a first user input which may include first information about a first storage engine (e.g., the first storage engine 108) associated with a database server (e.g., the database server 104). The operations further include reception of a second user input which may include second information about a second storage engine (e.g., the second storage engine 110) associated with the database server. The operations further include reception of a third user input which may include third information about a set of database tables (e.g., the set of database tables 112) associated with the first storage engine. The first user input, the second user input, and the third user input may be received for a modification of a storage engine of a first database table (e.g., the first database table 112A) of the set of database tables from the first storage engine to the second storage engine. The operations further include determination of a compatibility score which indicates a compatibility between the first storage engine and the second storage engine based on the received first user input, the received second user input, and the received third user input. The operations further include modification of first metadata information, associated with the first database table, based on the determined compatibility score to modify the storage engine of the first database table from the first storage engine to the second storage engine.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively, or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer-readable storage media such as computer readable media that store data for short periods of time like register memory and processor cache. The computer readable media can further include non-transitory computer readable media that store program code and/or data for longer periods of time. Thus, the computer readable media may include secondary or persistent long-term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures. While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

1. A computing system, comprising:
a processor configured to:
receive a first user input which comprises first information that identifies a first storage engine associated with a database server;
receive a second user input which comprises second information that identifies a second storage engine associated with the database server, wherein the first storage engine and second storage engine are different storage engines;
receive a third user input which comprises third information that identifies a set of database tables that are associated with the first storage engine, wherein the first user input, the second user input, and the third user input are received for a modification of a storage engine of a first database table of the set of database tables from the first storage engine to the second storage engine;
determine a compatibility score which indicates a compatibility between the first storage engine and the second storage engine based on the received first user input, the received second user input, and the received third user input; and
responsive to determining, based on the compatibility score, that the first storage engine and the second storage engine are compatible, modify first metadata information, associated with the first database table, to modify the storage engine of the first database table from the first storage engine to the second storage engine.

2. The computing system according to claim 1, wherein the processor is further configured to transmit a command to the database server to create a copy of the first database table, wherein the copy of the first database table is associated with the second storage engine.

3. The computing system according to claim 1, wherein the processor is further configured to:
determine the first metadata information associated with the first database table of the set of database tables associated with the first storage engine; and
determine second metadata information associated with a copy of the first database table, wherein the copy of the first database table is associated with the second storage engine.

4. The computing system according to claim 3, wherein the processor is further configured to:
compare a first set of parameters of the determined first metadata information with the first set of parameters of the determined second metadata information; and
determine the compatibility score which indicates the compatibility between the first storage engine and the second storage engine based on the comparison.

5. The computing system according to claim 4, wherein the first set of parameters comprises at least of: a first parameter associated with a version of a database, a second parameter associated with a minimum number of rows in the first database table, a third parameter associated with a maximum number of rows in the first database table, a fourth parameter associated with a key length of a primary key of the first database table, and a fifth parameter associated with an Input/Output (I/O) size of the first database table.

6. The computing system according to claim 1, wherein the processor is further configured to:
determine a second set of parameters to be modified in the first metadata information based on the determined compatibility score; and
modify the determined second set of parameters in the first metadata information to modify the storage engine of the first database table.

7. The computing system according to claim 6, wherein the determined second set of parameters comprises at least of: a name parameter, and a type-code parameter.

8. The computing system according to claim 1, wherein the processor is further configured to transmit a command to the database server to re-start the database server, and wherein the database server is re-started to reflect the modification of the first metadata information.

9. The computing system according to claim 1, wherein the first metadata information comprises at least of: a first section, a second section, a third section, or a fourth section, and wherein
the first section corresponds to a header section,
the second section corresponds to a key information section,
the third section corresponds to a comment section, and
the fourth section corresponds to a column information section.

10. The computing system according to claim 1, wherein the processor is further configured to:
determine second metadata information associated with a copy of the first database table associated with the second storage engine;
compare a first set of parameters of the first metadata information with the first set of parameters of the determined second metadata information; and
transmit an alter command to the database server to modify the storage engine of the first database table based on the comparison.

11. The computing system according to claim 10, wherein the alter command is to modify the storage engine of the first database table of the set of database tables from the first storage engine to the second storage engine.

12. A method, comprising:
in a computing system:
receiving a first user input which comprises first information that identifies a first storage engine associated with a database server;
receiving a second user input which comprises second information that identifies a second storage engine associated with the database server, wherein the first storage engine and second storage engine are different storage engines;
receiving a third user input which comprises third information that identifies a set of database tables that are associated with the first storage engine, wherein the first user input, the second user input, and the third user input are received for a modification of a storage engine of a first database table of the set of database tables from the first storage engine to the second storage engine;
determining a compatibility score which indicates a compatibility between the first storage engine and the second storage engine based on the received first user input, the received second user input, and the received third user input; and
responsive to determining, based on the compatibility score, that the first storage engine and the second storage engine are compatible, modifying first metadata information, associated with the first database table, to modify the storage engine of the first database table from the first storage engine to the second storage engine.

13. The method according to claim 12, further comprising transmitting a command to the database server to create a copy of the first database table, wherein the copy of the first database table is associated with the second storage engine.

14. The method according to claim 12, further comprising:
determining the first metadata information associated with the first database table of the set of database tables associated with the first storage engine; and
determining second metadata information associated with a copy of the first database table, wherein the copy of the first database table is associated with the second storage engine.

15. The method according to claim 14, further comprising:
comparing a first set of parameters of the determined first metadata information with the first set of parameters of the determined second metadata information; and
determining the compatibility score which indicates the compatibility between the first storage engine and the second storage engine based on the comparison.

16. The method according to claim 12, further comprising:
determining a second set of parameters to be modified in the first metadata information based on the determined compatibility score; and
modifying the determined second set of parameters in the first metadata information to modify the storage engine of the first database table.

17. The method according to claim 16, wherein the determined second set of parameters comprises at least of: a name parameter, and a type-code parameter.

18. The method according to claim 12, further comprising transmitting a command to the database server to re-start the database server, wherein the database server is re-started to reflect the modification of the first metadata information.

19. The method according to claim 12, wherein the first metadata information comprises at least of: a first section, a second section, a third section, or a fourth section, and wherein
the first section corresponds to a header section,
the second section corresponds to a key information section,
the third section corresponds to a comment section, and
the fourth section corresponds to a column information section.

20. A non-transitory computer-readable storage medium configured to store instructions that, in response to being executed, causes a computing system to perform operations, the operations comprising:
receiving a first user input which comprises first information that identifies a first storage engine associated with a database server;
receiving a second user input which comprises second information that identifies a second storage engine associated with the database server, wherein the first storage engine and second storage engine are different storage engines;
receiving a third user input which comprises third information that identifies a set of database tables that are associated with the first storage engine, wherein the first user input, the second user input, and the third user input are received for a modification of a storage engine of a first database table of the set of database tables from the first storage engine to the second storage engine;
determining a compatibility score which indicates a compatibility between the first storage engine and the second storage engine based on the received first user input, the received second user input, and the received third user input; and
responsive to determining, based on the compatibility score, that the first storage engine and the second storage engine are compatible, modifying first metadata information, associated with the first database table, to modify the storage engine of the first database table from the first storage engine to the second storage engine.
